(19) United States
(12) Patent Application Publication
(10) Pub. No.: US 2025/0356185 A1
(43) Pub. Date: Nov. 20, 2025

(54) SPARSE HIGH RANK ADAPTERS AND THEIR HARDWARE-SOFTWARE CO-DESIGN

(71) Applicant: QUALCOMM Incorporated, San Diego, CA (US)

(72) Inventors: Kartikeya BHARDWAJ, San Diego, CA (US); Nilesh Prasad PANDEY, La Jolla, CA (US); Sweta PRIYADARSHI, San Diego, CA (US); Shubhankar Mangesh BORSE, San Diego, CA (US); Shreya KADAMBI, San Diego, CA (US); Rafael Xavier ESTEVES, San Diego, CA (US); Viswanath GANAPATHY, San Ramon, CA (US); Risheek GARREPALLI, San Diego, CA (US); Paul Nicholas WHATMOUGH, Cambridge, MA (US); Marinus Willem VAN BAALEN, Amsterdam (NL); Markus NAGEL, Amsterdam (NL)

(21) Appl. No.: 18/884,003

(22) Filed: Sep. 12, 2024

Related U.S. Application Data
(60) Provisional application No. 63/647,353, filed on May 14, 2024.

(51) Int. Cl. G06N 3/08

(52) U.S. Cl. CPC G06N 3/08

(57) ABSTRACT

A processor-implemented method includes receiving an artificial neural network having a number of pre-trained weights. The method also includes training a subset of the number of pre-trained weights to obtain trained sparse adapter weights for obtaining a fine-tuned version of the artificial neural network. The subset of the number of pre-trained weights includes base model weights of a base model for the artificial neural network. The subset of the number of pre-trained weights is selected with a sparse mask of a sparse adapter. The method may also include replacing the subset of the number of pre-trained weights with the trained sparse adapter weights.

### CROSS-REFERENCE TO RELATED APPLICATION

The present application claims the benefit of U.S. Provisional Patent Application No. 63/647,353, filed on May 14, 2024, and titled “SPARSE HIGH RANK ADAPTERS AND THEIR HARDWARE-SOFTWARE CODESIGN,” the disclosure of which is expressly incorporated by reference in its entirety.

### FIELD OF THE DISCLOSURE

Aspects of the present disclosure generally relate to artificial neural networks, and more specifically to hardware-software co-design of sparse high rank adapters for artificial neural networks.

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs) and transformers are types of feed-forward and attention based ANNs, respectively. Artificial neural networks may include collections of neurons that each have a receptive field and that collectively tile an input space. Artificial neural networks, such as deep convolutional neural networks (DCNs), have numerous applications. In particular, these neural network architectures are used in various technologies, such as image recognition, image generation, text generation, video generation, speech recognition, audio generation, natural language processing, acoustic scene classification, keyword spotting, autonomous driving, extended reality (XR), camera/video and other tasks.

Image generation and video generation may be performed with generative artificial intelligence (AI) models. Adapting these large models towards a new application is computationally intensive. Adaptation of the models generally specifies training/fine-tuning portions of the large model. It would be desirable to more efficiently fine-tune generative AI models.

### SUMMARY

Aspects of the present disclosure are directed to an apparatus. The apparatus has one or more memories and one or more processors coupled to the memory. The processor(s) is configured to receive an artificial neural network having a number of pre-trained weights. The processor(s) is also configured to train a subset of the number of pre-trained weights to obtain trained sparse adapter weights for obtaining a fine-tuned version of the artificial neural network. The subset of the number of pre-trained weights includes base model weights of a base model for the artificial neural network. The subset of the number of pre-trained weights is selected with a sparse mask of a sparse adapter. The trained sparse adapter weights may be used to replace the subset of the number of pre-trained weights with the trained sparse adapter weights.

In other aspects of the present disclosure, a processor-implemented method includes receiving an artificial neural network having a number of pre-trained weights. The method also includes training a subset of the number of pre-trained weights to obtain trained sparse adapter weights for obtaining a fine-tuned version of the artificial neural network. The subset of the number of pre-trained weights includes base model weights of a base model for the artificial neural network. The subset of the number of pre-trained weights is selected with a sparse mask of a sparse adapter. The trained sparse adapter weights may be used for replacing the subset of the number of pre-trained weights with the trained sparse adapter weights.

In other aspects of the present disclosure, a non-transitory computer-readable medium with program code recorded thereon is disclosed. The program code is executed by a processor and includes program code to receive an artificial neural network having a number of pre-trained weights. The program code also includes program code to train a subset of the number of pre-trained weights to obtain trained sparse adapter weights for obtaining a fine-tuned version of the artificial neural network including. The subset of the number of pre-trained weights includes base model weights of a base model for the artificial neural network. The subset of the number of pre-trained weights is selected with a sparse mask of a sparse adapter. The trained sparse adapter weights may be used to replace the subset of the number of pre-trained weights with the trained sparse adapter weights.

Other aspects of the present disclosure are directed to an apparatus. The apparatus includes means for receiving an artificial neural network having a number of pre-trained weights. The apparatus also includes means for training a subset of the number of pre-trained weights to obtain trained sparse adapter weights for obtaining a fine-tuned version of the artificial neural network. The subset of the number of pre-trained weights includes base model weights of a base model for the artificial neural network. The subset of the number of pre-trained weights is selected with a sparse mask of a sparse adapter. The trained sparse adapter weights may be used for replacing the subset of the number of pre-trained weights with the trained sparse adapter weights.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance various with aspects of the present disclosure.

FIG. 3 is a block diagram illustrating an exemplary deep convolutional network (DCN) in accordance with various aspects of the present disclosure.

FIG. 4 is a block diagram illustrating an exemplary software architecture that may modularize artificial intelligence (AI) functions, in accordance various with aspects of the present disclosure.

FIG. 5 is a block diagram illustrating low rank adaptation (LoRA) of a generative artificial intelligence (AI) model.

FIG. 6 is a block diagram illustrating multi-adapter low rank adaptation (LoRA) of a generative artificial intelligence (AI) model.

FIG. 7 is a block diagram illustrating a sparse high rank adapter (SHIRA) of a generative artificial intelligence (AI) model, in accordance with various aspects of the present disclosure.

FIG. 8 is a block diagram illustrating additional aspects of sparse high rank adaptation (SHIRA) of a generative artificial intelligence (AI) model, in accordance with various aspects of the present disclosure.

FIG. 9 is a block diagram illustrating multi-adapter sparse high rank adaptation (SHIRA) of a generative artificial intelligence (AI) model, in accordance with various aspects of the present disclosure.

FIG. 10 is a block diagram illustrating co-design of hardware and software for multi-adapter sparse high rank adaptation (SHIRA) of a generative artificial intelligence (AI) model, in accordance with various aspects of the present disclosure.

FIG. 11 is a flow diagram illustrating a processor-implemented method for implementing sparse adapters, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Text generation, language generation, image generation, and video generation may be performed with generative artificial intelligence (AI) models. These models have many applications in autonomous driving, camera/video technology, extended reality (XR), augmented reality (AR), virtual reality (VR), etc. Adapting these large models to a new application is computationally intensive. Adaptation of the models generally specifies training/fine-tuning portions of the large model. Differing applications may include style transfer into multiple concepts/effects for vision models, as well as translation, common sense reasoning, and math for language models, for example.

Although adapters, such as low-rank adaptation (LoRA), are efficient at retraining networks, rapid switching of adapters is not efficient. See for example LoRA: Low Rank Adaptation of Large Language Models by Hu at al. and Mixture of LoRA Experts by Wu et al. Unfortunately, large latencies result from rapid switching. Aspects of the present disclosure introduce solutions for performing rapid adapter switching while keeping adapters fused into a base model having pre-trained weights.

Multiple adapters may be used at the same time to adapt a given generative model to multiple tasks or image styles. Because a fused LoRA adapter may completely overwrite the original weights, adding multiple LoRA adapters could overwrite each additional adapter, resulting in concept loss. That is, one or more concepts may not appear or may appear with a reduced effect in the final output. Aspects of the present disclosure present techniques for merging multiple adapters together without overwriting each other's effects.

Aspects of the present disclosure introduce a sparse high-rank adaptation (SHIRA) adapter. The SHIRA adapter enables rapid adapter switching directly on a fused model. Additionally, the SHIRA adapter may also provide an easy way to merge multiple adapters without overwriting each adapter. Furthermore, the SHIRA adapter may have a relatively small size, enabling hardware-software co-design solutions to further accelerate adapter inferences. More specifically, a small-sized adapter can result in a significantly smaller look-up table that would indicate which pretrained base weights need to be replaced with which SHIRA weights. Thus, a software implementation for SHIRA is easy to support and has a low memory footprint due to the small look-up table size. Additionally, explicit hardware designs can further accelerate SHIRA loading by having explicit hardware and decode operations that can load SHIRA weights quickly. Finally, according to various aspects, the SHIRA adapter may train a small subset of pre-trained model weights by masking gradients during training. Both structured and unstructured masks are available options for such a process.

In some aspects, the mentioned sparse masks of the adapter have little overlap between each other. As a result, rapid adapter switching and multi-adapter fusion may be enabled. Rapid adapter switching may be enabled because the new adapter allows for a fused adapter to be trained directly using a fraction of the parameters of the pre-trained model. Unlike prior adapters, there is no need to fuse the adapter post-training.

Particular aspects of the subject matter described in this disclosure can be implemented to realize one or more of the following potential advantages. In some examples, the described sparse adapters may improve efficiency of adapter switching in fused mode because only a low percentage of weights of a base model are overwritten. Moreover, multi-adapter fusion is enabled with little to no concept loss. Thus, data storage is decreased and hardware processing speed is increased.

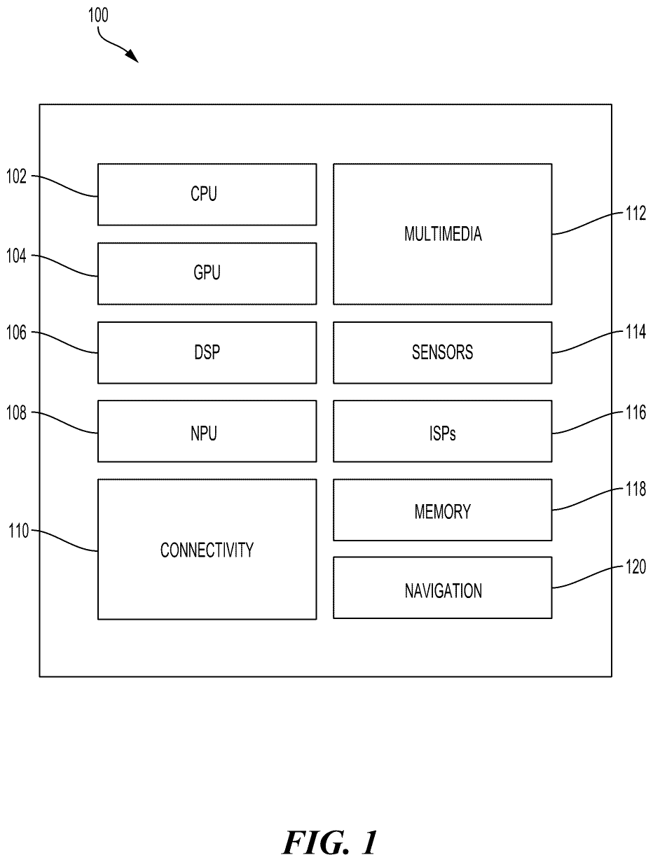

FIG. 1 illustrates an example implementation of a system-on-a-chip (SOC) 100, which may include a central processing unit (CPU) 102 or a multi-core CPU configured for training of generative AI models with sparse adapters. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to receive an artificial neural network having a number of pre-trained weights. The general-purpose processor 102 may also include code to train a subset of the number of pre-trained weights to obtain trained sparse adapter weights for obtaining a fine-tuned version of the artificial neural network. The subset of the number of pre-trained weights includes base model weights of a base model for the artificial neural network. The subset of the number of pre-trained weights is selected with a sparse mask of a sparse adapter. The trained sparse adapter weights may be used to replace the subset of the number of pre-trained weights with the trained sparse adapter weights.

In some aspects, the general-purpose processor 102 may include means for receiving, means for training, means for storing, means for decoding and means for accessing.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

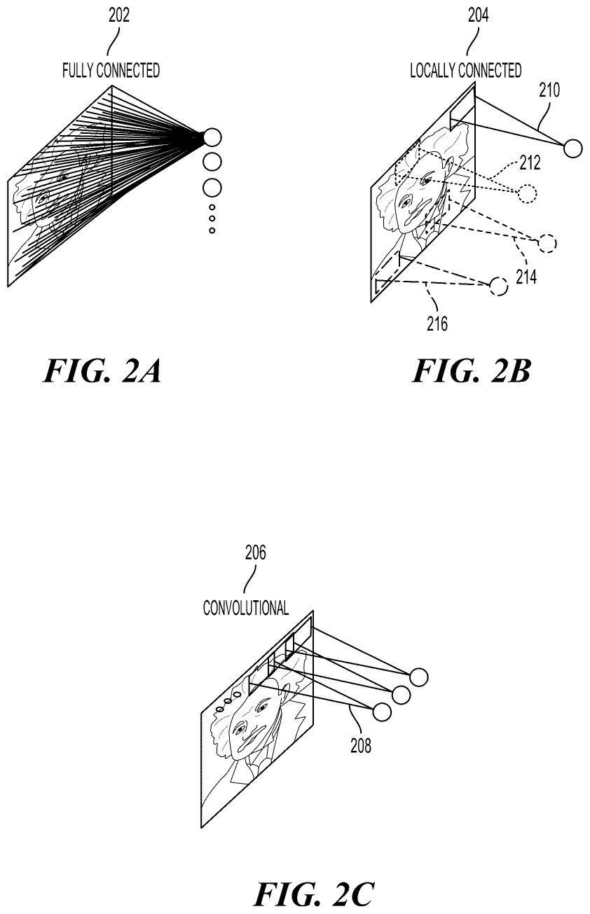

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

Although the present application applies to convolutional and linear layers, as well as transformer networks, an example will be described with respect to one type of convolutional neural network that is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max (0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

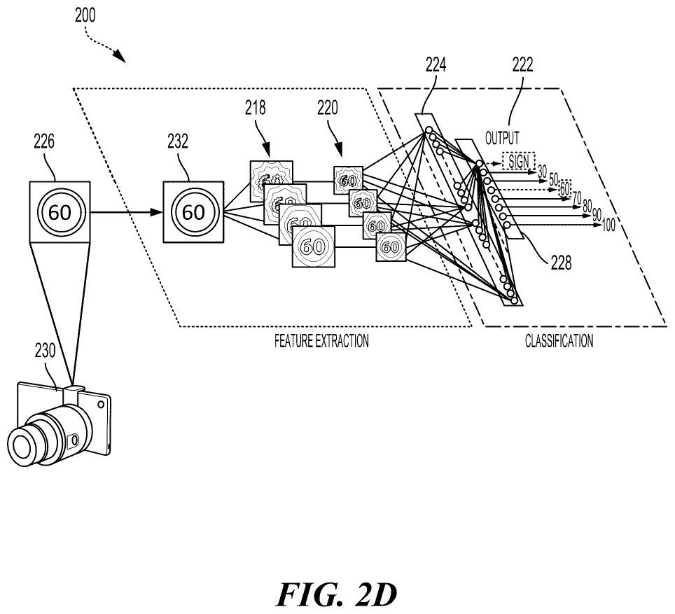

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

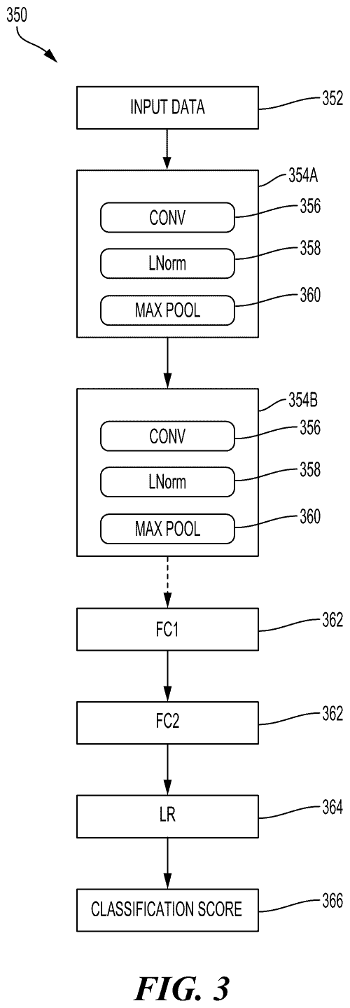

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to receive an artificial neural network having a number of pre-trained weights for an AI application 402, according to aspects of the present disclosure. Applications may also be designed that may cause various processing blocks of an SOC 420 to train a subset of the number of pre-trained weights to obtain trained sparse adapter weights for obtaining a fine-tuned version of the artificial neural network, the subset of the number of pre-trained weights comprising base model weights of a base model for the artificial neural network, the subset of the plurality of pre-trained weights selected with a sparse mask of a sparse adapter, for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

Text generation, language generation, image generation, and video generation may be performed with generative artificial intelligence (AI) models. These models have many applications in autonomous driving, camera/video technology, extended reality (XR), augmented reality (AR), virtual reality (VR), etc. Adapting these large models to a new application is computationally intensive. Adaptation of the models generally specifies training/fine-tuning portions of the large model. Differing applications may include style transfer into multiple concepts/effects for vision models, as well as translation, common sense reasoning, and math for language models, for example.

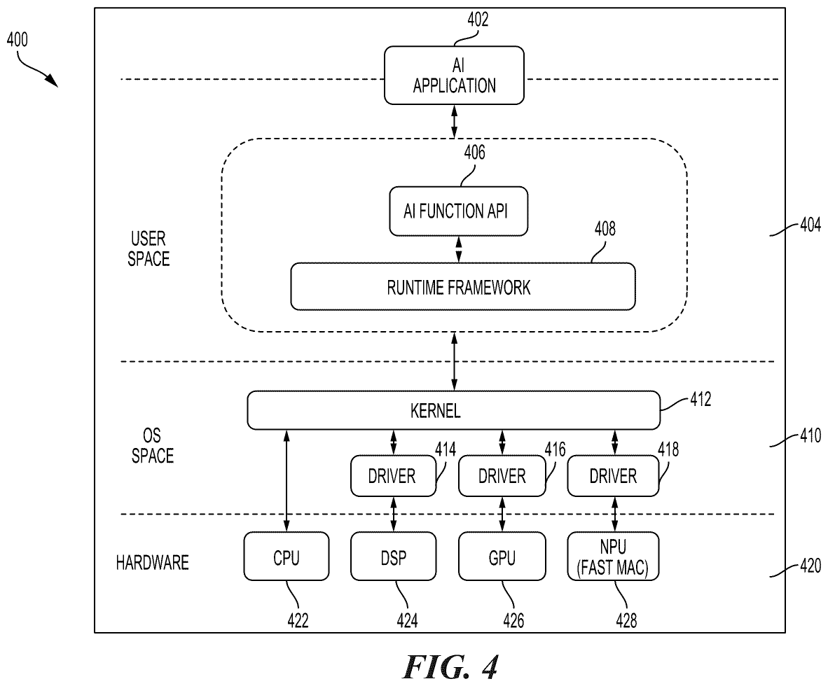

Low-rank adaptation (LoRA) is an established method for fine-tuning large generative AI models towards new tasks. With LoRA, adapters can be analytically fused into base model weights, thus eliminating additional overhead during inference. Fused weights are defined such that there is no branch of weights alongside pretrained weights, for example, as seen in FIG. 5. With fused weights, specific indices in the pretrained weights are overwritten with the corresponding sparse weights.

FIG. 5 is a block diagram illustrating low-rank adaptation (LoRA) of a generative AI model. As shown in the example of FIG. 5, there is an input X having a dimension d. An output h is obtained by preprocessing input x through a linear layer containing pre-trained weights W as well as additional adapter linear layers containing weight matrices A and B, each having rank r. As is well known, a rank corresponds to a number of linearly independent rows or columns. Although adapter layers in this example are linear layers, adapter convolutions are also possible where the rank r corresponds to a reduced number of channels. The additional weights are fine-tuned with initial values set to zero for B, and the normal distribution with a mean of zero for A.

Although adapters, such as LoRA, are efficient at retraining networks, rapid switching of adapters is not efficient. For instance, a user may elect to switch adapters quickly on a device with limited resources. For example, if application developers want users to quickly experiment with various image styles, rapidly changing adapters on-device would be specified. Unfortunately, large latencies result from rapid adapter switching, particularly when LoRA is used in the fused mode.

Generative AI models are very large. For example, some image generators have 1.5 billion parameters, some large language models have 10 or more billion parameters. Switching all weights whenever an adapter changes would incur a massive inference latency. Alternatively, keeping the adapter unfused would also incur latency overhead from extra operations, thereby defeating the fusing benefit of techniques such as LoRA.

Aspects of the present disclosure introduce solutions for performing rapid adapter switching while keeping adapters fused into a base model.

Multiple adapters may be used at the same time to adapt a given generative model to multiple tasks or image styles. Because a fused LoRA adapter completely overwrites the original weights, adding multiple LoRA adapters could overwrite each other adapter. The overwriting may result in concept loss. That is, one or more concepts do not appear or appear with a reduced effect in the final output.

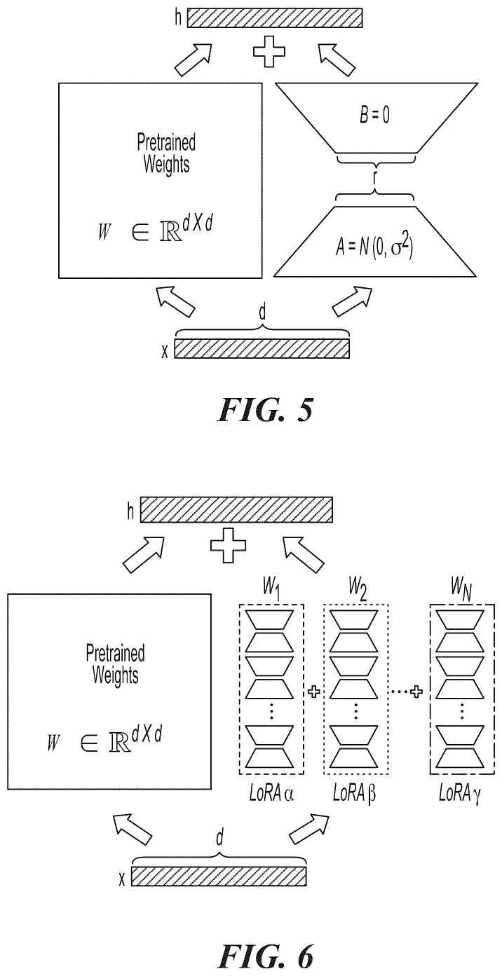

FIG. 6 is a block diagram illustrating multi-adapter low-rank adaptation (LoRA) of a generative artificial intelligence (AI) model. In the example of FIG. 6, multiple LoRA adapters (LoRA α, LoRA β, . . . . LoRA γ) are shown, each resulting in a different set of adapter weights (w₁, w₂, . . . w_{N}). When a second LoRA adapter (e.g., LoRA β) is employed, the weights (e.g., w₂) from that second adapter (e.g., LoRA β) may overwrite another set of weights (e.g., w₁) from another adapter (e.g., LoRA α.)

Aspects of the present disclosure present techniques for merging multiple adapters together without overwriting each other's effects, reducing concept loss. Aspects also enable rapid switching for previously fused adapters. These aspects include high rank adapters that have high expressive power without significantly increasing the training or inference costs.

According to aspects of the present disclosure, a sparse high-rank adapter (SHIRA) enables rapid adapter switching directly on a fused model. The new adapter also provides a way to merge multiple adapters without overwriting each other. The new sparse adapter has a relatively small size. The small size may enable hardware-software co-design solutions to further accelerate adapter inferences. In contrast to existing LoRA adapters that add additional weights during training, the new SHIRA adapter does not add any new weights. Rather, the new SHIRA adapter trains a small subset of pre-trained model weights by masking gradients during training.

The new sparse high rank adapter enables changing as few as 1-2% of parameters of the original network while still being able to perform adaptation tasks. SHIRA enables on-device rapid adapter switching and provides a natural multi-adapter fusion technique due to high sparsity, thus, significantly reducing concept loss. SHIRA significantly outperforms LoRA on both single- and multi-adapter tasks. On the training side, SHIRA trains nearly as fast as standard LoRA while consuming lower peak GPU memory. For inference, SHIRA weights can be loaded on a CPU up to 10 times faster than equivalent LoRA fusing, thereby enabling rapid switching.

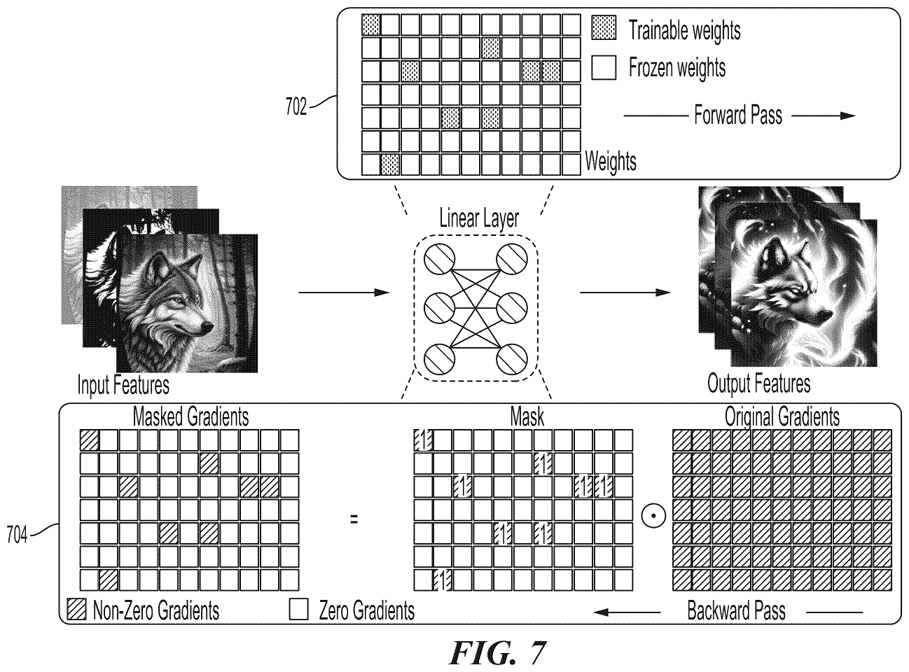

FIG. 7 is a block diagram illustrating a sparse high-rank adapter (SHIRA) of a generative artificial intelligence (AI) model, in accordance with various aspects of the present disclosure. As seen in FIG. 7, SHIRA exploits highly sparse trainable parameters in the pre-trained base model. In its simplest form, the proposed adapter can be trained by masking gradients such that only a fraction of original weights is updated. Specifically, new weights are not added to the forward pass like LoRA, but rather, a small percentage of existing weights are trainable, as seen in block 702.

As seen in block 704, an extremely sparse (e.g., 98-99% zeros) mask [symbol] ∈ [symbol] ^{n×m}={0, 1}^{n×m}, where n×m are dimensions of the pre-trained weight matrix, is used to mask the gradients during backpropagation using a Hadamard product. As a result, very few parameters are updated during training and the adapter only consists of those sparse weights. A concrete gradient masking-based implementation and another latency-/memory-efficient parameter efficient fine-tuning (PEFT)-based implementation for SHIRA are discussed below in more detail.

Various strategies to create the mask [symbol] are now described. Note that, in some implementations, only 1-2% of the parameters are set as trainable in each case:

In a first mask, referred to as SHIRA-Struct, certain rows or columns of the weight matrix, as well as the diagonal, are set to be trainable. All other rows and columns are not trainable. The diagonal makes the mask high rank, whereas the structured trainable rows and columns are set to one to enable gradient flow to corresponding parameters, leading to a rank one adapter. Thus, the SHIRA-Struct mask is a high rank but a very sparse adapter and a rank 1 adapter.

In a second mask, referred to as SHIRA-Rand, 1-2% (or other percentage) of parameters are randomly set as trainable. In a third mask, referred to as SHIRA-WM, top-K parameters are selected to train based on their weight magnitudes (WM), e.g., the absolute value of the weight for each layer. A fourth mask, referred to as SHIRA-Grad, is a gradient-based mask. For this mask, gradients are collected on a small calibration set, and then the top 1-2% (or other percentage) of weights that receive the highest gradient magnitudes are selected. A fifth mask, referred to as SHIRA-SNIP, is based on single-shot pruning network (e.g., scaled neural indirect predictor (SNIP)) metrics used in pruning techniques. For this mask, weight magnitude and gradient strategies are combined where SNIP equals gradient magnitude times the weight magnitude.

Rapid adapter switching, multi-adapter fusion, and high rank will now be discussed in more detail. Because very few base weights change during the SHIRA training, the weights may be extracted and stored as sparse weights and their indices. Hence, SHIRA is comparable to LoRA in model size but overwrites only a fraction of the pre-trained weights at inference time. In contrast, LoRA fuses into base weights as W_{new}=W+AB and changes the entire weight matrix. Note that SHIRA may not be fused, but rather, the modified values may be overwritten at the correct index in the pre-trained weight tensor, enabling rapid switching on resource-constrained devices. An implementation based on a scatter operation may overwrite the base model weights instead of fusing them like LoRA, demonstrates that on a CPU, weight loading for SHIRA adapters can be up to 10 times faster than equivalent LoRA fusing for inference.

Next, multi-adapter fusion in SHIRA is discussed. Assume two adapters A1 and A2 with sparse masks M1 and M2 are received. There are two aspects to consider here: (i) what is the impact of sparsity on relative interference between adapters in the multi-adapter setting; and (ii) is it possible to create certain types of masks that result in nearly orthogonal SHIRA weights so they do not significantly interfere with each other at inference time?

Obtaining metrics that do not interfere with each other is essential to avoid concept-loss. To this end, specific metrics are defined to analyze orthogonality properties between adapter weights for various SHIRA strategies. At least one of the SHIRA masks, (e.g., SHIRA-Struct) may create near-orthogonal adapters. Finally, because no low rank weights are present in the forward pass, the proposed adapters can be high rank albeit highly sparse.

Two implementations for SHIRA are considered: (i) a backward hook-based gradient masking to turn any trainer into SHiRA fine-tuning; and (ii) a PEFT-based implementation.

The parameter complexity and learning complexity of SHIRA is equal to the number of non-zero elements in the adapter. This suggests that despite the high rank property of SHIRA, significantly larger datasets are not specified for convergence.

If a sparsity factor is specified, the LoRA is an r rank approximation of SHIRA with approximation error bounded by

$${σ}_{r + 1}^{2} ,$$

the (r+1)^{th} singular value of the SHIRA adapter.

The scaling factor for SHIRA is independent of the rank of the adapter and can be set to one. In other words, scaling factors are not needed to stabilize the training and, therefore, additional hyperparameters, such as a or independent learning rates for separate A and B matrices are not needed. Of note, the scaling factor α can still be used at inference time to vary the intensity of the adapter.

Adapter weight orthogonality in multi-adapter fusion is now discussed. Consider two adapters, ΔW₁ and ΔW₂. If one of the adapters, ΔW₁ or ΔW₂ lies in the null space of the other, then the adapters will not interfere multiplicatively. The above implies that two adapters can be efficiently fused without interference if they are orthogonal. In order to analyze the orthogonality between any two adapter weights, the following metrics are defined:

Adapter weight orthogonality magnitude (AWOM) is defined as the l₂ norm of the product

$${A}_{1}^{T} {A}_{2}$$

for two sparse adapter weights A₁, A₂∈ [symbol] ^{n×m}. AWOM enables understanding of how far the product

$${A}_{1}^{T} {A}_{2}$$

is from a zero matrix [symbol] ∈ [symbol] ^{m×m}( [symbol] _{i,j}={0}∀i,j).

Adapter weight orthogonality ratio (AWOR) is defined as the sparsity ratio of the product

$${A}_{1}^{T} {A}_{2} .$$

### Specifically,

$$AWOR = [ 1 - ( \frac{{‖ {A}_{1}^{T} {A}_{2} ‖}_{0}}{{m}^{2}} ) ]$$

where m² is the number of elements in

$${A}_{1}^{T} {A}_{2} .$$

Together, the metrics AWOM and AWOR provide an idea of relative orthogonality between adapter weights A₁ and A₂. Next, how at least one of the SHIRA strategies (e.g., SHIRA-Struct) can result in near-orthogonal adapters may be analyzed. Recall that SHIRA-Struct adapters train certain rows and columns and the diagonal elements while freezing all other parameters. Hence, the final trained adapter (after subtracting the pre-trained weight) contains a structured pattern of rows, columns, and diagonal elements. All other elements are set to zero. Now, without loss of generality, consider two SHIRA-Struct adapters for a layer with square m×m weights: A₁= [symbol] +S₁ and A₂= [symbol] +S₂, where S₁ and S₂ are row-wise patterns of trained weights for two different tasks, and [symbol] is an identity matrix. Also, S₁ and S₂ are non-overlapping, e.g., both have a same number of non-zero rows but are offset from each other such that they do not have any common trained rows. Then, the following result holds: non-overlapping SHIRA-Struct adapters are nearly orthogonal. That is, AWOR for non-overlapping SHIRA-Struct adapters is, at most, the sum of sparsity of individual adapters. Because all SHIRA masks are highly sparse, this means that the product

$${A}_{1}^{T} {A}_{2}$$

has a high percentage of zeros, thus making the adapters nearly orthogonal.

Although the mask SHIRA-Struct, is still a rank 1+diagonal adapter, single adapter performance (which strongly depends on adapter's expressive power) is a trade off against multi-adapter fusion capabilities. For instance, while SHIRA-Struct performs well for vision tasks, SHIRA-SNIP performs well across both large vision models and large language models.

The orthogonality property leads to a disentangled representation for adapter outputs before they merge into the base model. However, this property may not hold for SHIRA masks that do not have a regular sparsity pattern like SHIRA-Struct even if other SHIRA strategies are more orthogonal than LoRA weights. Importantly, this analysis focuses on orthogonality of adapter weights and not on orthogonality of subspaces.

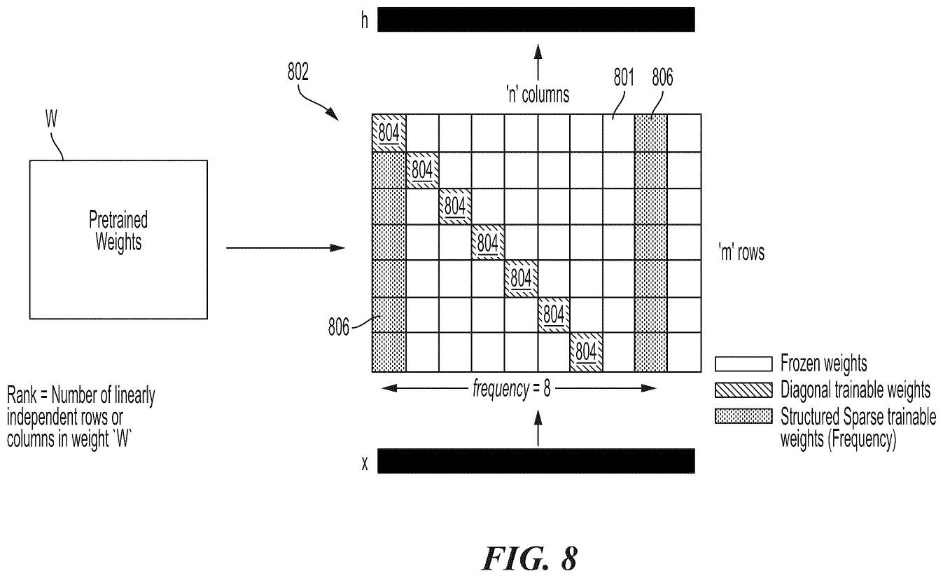

FIG. 8 is a block diagram illustrating sparse high-rank adaptation (SHIRA) of a generative artificial intelligence (AI) model, in accordance with various aspects of the present disclosure. In the example of FIG. 8, gradients obtained during training of a model with pre-trained weights W are masked with a sparse mask 802 having n columns and m rows. In the example of FIG. 8, the sparse mask 802 includes frozen weights 801, which are not revised during training. A diagonal of trainable weights 804, and a set of structured sparse trainable weights 806 are, however, modified during training. The diagonal of trainable weights 804 creates a high-rank adapter mask because a number of linearly independent rows or columns in the weights W is always high. A frequency parameter creates structure in the sparse mask 802 by training certain rows or columns in the weights. Here the frequency parameter f defines that every f rows or columns have an adapter parameter. If the number of columns is greater than the number of rows, the rows are trained. If the number of rows is greater than the number of columns (as in the example of FIG. 8), then the columns are trained. In the example of FIG. 8, two columns of weights are trained with a frequency of eight (e.g., every eighth column is trained).

Although a mask with a diagonal and a frequency is illustrated in FIG. 8, other types of sparse masks are also contemplated, both structured and unstructured. For example, to define unstructured masks, weight magnitude based unstructured masks are used. The absolute value of the weights may be considered in a top-K weight magnitude computation. Specifically, a mask is created by choosing the top-K weight magnitudes at specific layers where the sparse high rank adapter is employed. These top-K weights are fine-tuned, and the rest of the weights are frozen to their pre-trained values. The value K may be set to a small percentage of parameters so that the overall number of parameters to be tuned stays comparable to LoRA and its variants.

Despite the efficacy of employing a weight magnitude-based scheme, this approach lacks an inherent awareness of the specific task for which the model is being fine-tuned. To address this challenge, aspects of the present disclosure include a similar gradient magnitude-based proxy design to identity important top-K weights for the task and only adapt them during the fine-tuning process.

In still other implementations, sparse masks are learned by making a mask a learnable parameter during fine-tuning. Statistical heuristic based unstructured masks are also contemplated, as are masks based on single shot network pruning (e.g., single shot network pruning based on connection sensitivity (SNIP)).

SNIP combines both weight and gradient based schemes and jointly measures the importance of the weights by ranking them on a score computed as the product of the weight magnitude and the norm of its corresponding gradient. This formulation effectively captures the interplay between the weight magnitude, which reflects its overall contribution to the model's output, and its gradient information, which encodes the weight's task-specific relevance during fine-tuning. SNIP for a weight parameter is defined as:

$$SNIP {=}^{△} \vert 〈 {Θ}_{i} , {∇}_{θ i} ℒ 〉 \vert , \qquad ( 1 )$$

where [symbol] represents an inner product, Θᵢ is a weight parameter, ∇_{θi}L is a gradient of the weight parameter with respect to a task loss L for an ith layer in the network.

Unstructured sparse random masks involve masking individual weights without any specific pattern or structure. The masked weights are randomly scattered throughout the weight tensor, resulting in a sparse weight tensor. However, as the weights are selected without considering their salience to the task, randomly selected unstructured masks may be sub-optimum for fine-tuning. One common way of constructing random sparse marks is using Bernoulli sampling:

$$f ( k ; p ) = \{ \begin{matrix}p & if k = 1 , \\ 1 - p & if k = 0.\end{matrix} , \qquad ( 2 )$$

where p is a probability of sampling 1 from the distribution.

The sparse masks of the present disclosure have little overlap between adapter weights, in contrast to existing adapters that overwrite the entire set of pre-trained weights. As a result, rapid adapter switching and multi-adapter fusion are enabled. Rapid adapter switching is enabled because the new sparse adapter allows a fused adapter to be trained directly using a fraction of the parameters of the pre-trained model. In the case of a mask including a diagonal and a frequency (e.g., the sparse mask 802 of FIG. 8), the diagonal allows the adapter to have a high rank, whereas the frequency creates a structured sparse mask, for example, every f rows or columns have an adapter parameter, etc. This sparse adapter also allows for an improved hardware-software implementation due to lower processing and memory requirements. Unlike prior adapters, such as LoRA, there is no need to fuse the adapter post-training. When an adapter switches, the new adapter can be directly overwritten on the pre-trained weights of the base model.

If multiple adapters are used at the same time, the adapters may be created with slightly different but non-overlapping masks. As a result, when multiple adapters are combined, the adapters do not overwrite each other, resulting in both adapter concepts being well preserved. That is, each adapter's weights are not overwritten to the same set of base weights, reducing or even preventing concept loss.

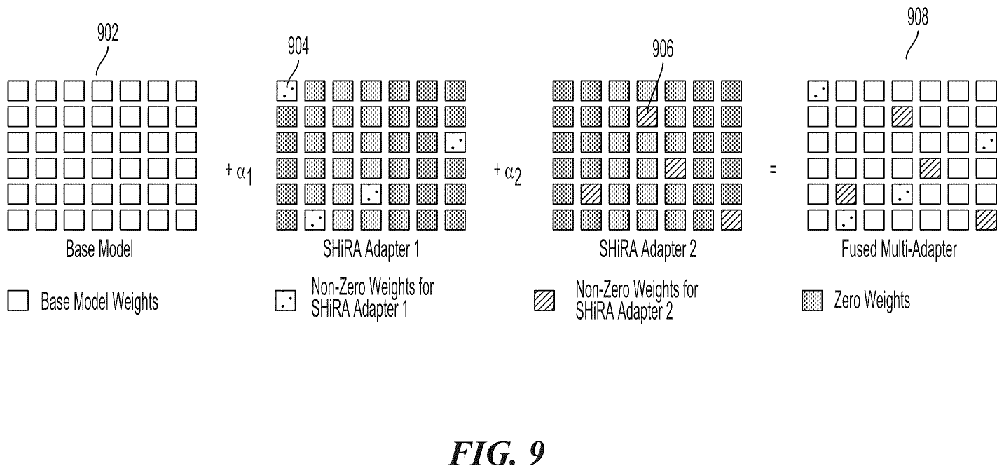

FIG. 9 is a block diagram illustrating multi-adapter sparse high-rank adaptation (SHIRA) of a generative artificial intelligence (AI) model, in accordance with various aspects of the present disclosure. In the example of FIG. 9, a first adapter α₁ and a second adapter α₂ are added to a base model 902 The first adapter α₁ has a first set of weights 904. The second adapter α₂ has a second set of weights 906. A fused multi-adapter 908 shows little or no overlap between the weights 904, 906. The adapters α₁, α₂ may be trained separately and merged during inference.

According to aspects of the present disclosure, weight decomposition is implemented by decomposing the weights of a pre-trained generative model into two parts: a sparse component and a base component. The sparse component corresponds to the adapter weights, while the base component represents the original pre-trained weights.

Sparse adapter representation is implemented by introducing sparse adapter matrices that are overwritten on top of the base model weights during the adapter inference process. The overwriting occurs instead of directly modifying the original weights, thereby preserving the original weights.

Additive weight updates during training include an adaptation process that learns sparse adapter weights that overwrite the corresponding base weights of the pre-trained model. During inference, this updating ensures that the original weights are preserved, allowing multiple adapters to be applied simultaneously without overwriting each other, as long as the masks for the multiple adapters are different.

With task-specific adapters, each task or image style can have its own dedicated sparse adapter. During the adaptation process, the corresponding sparse adapter weights are learned and applied additively to the base weights of the pre-trained model. By using multi-sparse adapters, overwriting is reduced as compared to existing techniques for multiple adapters (e.g., fused LoRA). Task-specific adapters preserve the original pre-trained weights while allowing for task-specific adaptations through sparse weight updates.

Although the present disclosure has primarily been described with respect to image generators, the sparse mask adapters may be applied to large language model (LLM) use cases or the like, as well.

The sparse mask adapter of the present disclosure may be supported in hardware. A new decode operation (op) or look-up table (LUT) may be introduced to take base weights and replace corresponding base model weights with the adapter weights. A look-up table based implementation is beneficial for both structured and unstructured adapters. Structured adapters may have additional benefits in terms of constructing a look up table. However, because the number of parameters being changed is small, look up tables are still very efficient, even for unstructured masks.

The process includes first storing sparse weights. Then, the new operation decodes the sparse weights and brings the sparse weights to the compute engines. Next, the process makes inferences, similar to inferences with the base model case, where no adapter weight (e.g., A and B from FIG. 5) unfused LoRA branches are needed.

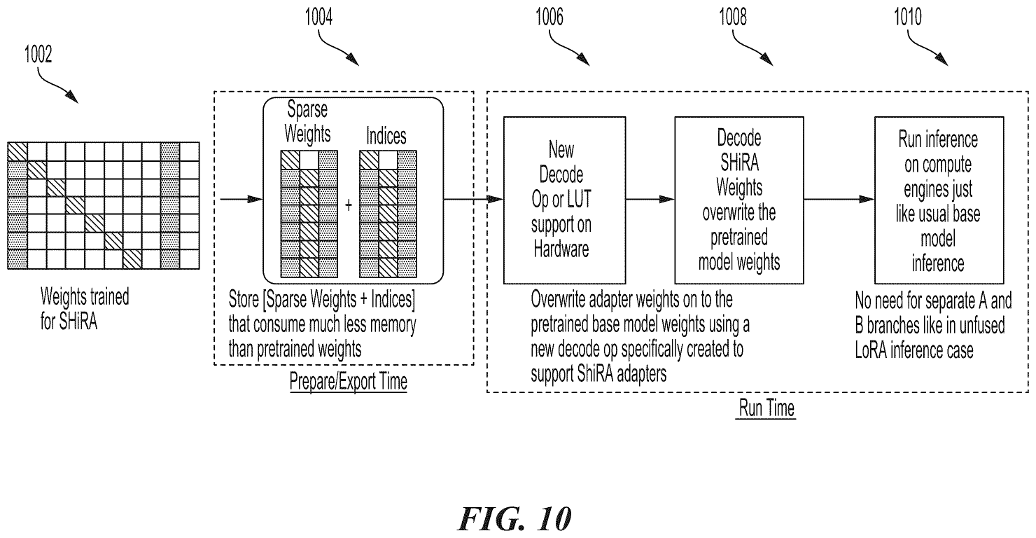

FIG. 10 is a block diagram illustrating co-design of hardware and software for multi-adapter sparse high-rank adaptation (SHIRA) of a generative artificial intelligence (AI) model, in accordance with various aspects of the present disclosure. In the example of FIG. 10, weights trained for a sparse model 1002 are stored (e.g., in memory) in an efficient manner. As seen in block 1004, sparse weights and corresponding indices are stored in two small memory blocks. The sparse weights may be scaled by an alpha factor, if desired. By storing the sparse weights and indices in the smaller memory blocks, less memory is consumed than would be the case if the full set of pre-trained weights or fused LoRA adapter weights (which are the same as pre-trained base model weights) were to be stored.

During run time, at block 1006, either the new decode operation or a look-up table supported on hardware is invoked to overwrite the adapter weights onto the pre-trained base model weights at block 1008. The new decode operation may be specifically created to support sparse adapters. At block 1010, inference is run on compute engines as it would occur for a base model inference. There is no need for separate branches, as with an unfused LoRA inference. That is, multiple adapters are applied simultaneously, increasing hardware processing speed compared to processing branches separately, such as with an unfused LoRA inference.

Integrating the sparse adapters into mobile devices improves performance and may lead to more efficient and powerful devices, improved AI processing capabilities, enhanced camera and image processing features, and accelerated AR/VR experiences. The new adapters are easy to apply during inference time with little to no overhead. For autonomous vehicles, XR-VR, mobile handsets, laptops, and Internet of things (IoT) devices, applying the sparse adapter in image generator use-cases improves performance and capabilities of self-driving cars, augmented reality, and day to day IoT devices, making the cars/devices safer and more reliable. For generative AI and AI assistants, the sparse adapter enhances the efficiency and quality of generative AI on-device personalization for image generators. The sparse adapter may advance generative AI methods, enabling more sophisticated and realistic content creation, data augmentation, and creative applications across various domains.

As seen from the above, the new sparse high rank adapter (SHIRA) paradigm demonstrates that even fine-tuning merely 1-2% parameters of the pre-trained generative models is sufficient to achieve high performance on many adapter tasks. SHIRA has the ability to rapidly switch adapters and avoid concept loss. Furthermore, specially designed sparse masks can lead to near-orthogonal adapter weights, allowing for multi-adapter fusion.

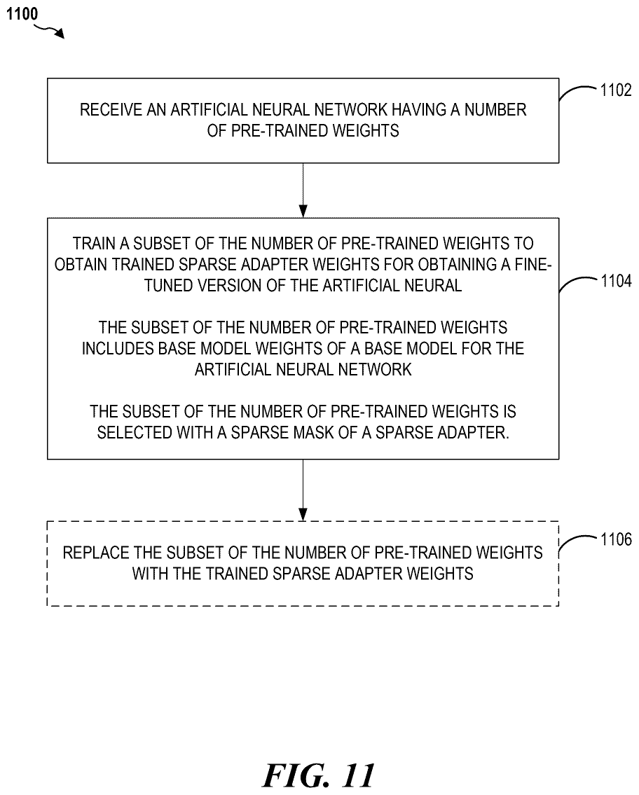

FIG. 11 is a flow diagram illustrating a processor-implemented method 1100 for implementing sparse adapters, such as those shown in FIGS. 7, 8, 9, and 10, in accordance with various aspects of the present disclosure. The processor-implemented method 1100 may be performed by one or more processors such as the CPU (e.g., 102, 422), GPU (e.g., 104, 426), and/or other processing unit (e.g., DSP 424, NPU 428). As shown in FIG. 11, in some aspects, the processor-implemented method 1100 includes receiving an artificial neural network having a number of pre-trained weights (block 1102). For example, the artificial neural network may be a CNN or a transformer network.

In some aspects, the processor-implemented method 1100 includes training a subset of the number of pre-trained weights to obtain trained sparse adapter weights for obtaining a fine-tuned version of the artificial neural network. The subset of the number of pre-trained weights includes base model weights of a base model for the artificial neural network. The subset of the number of pre-trained weights is selected with a sparse mask of a sparse adapter (block 1104). For example, the sparse mask may include offsetting sparse masks resulting in minimal overlapping for multi-adapter fusion. In other aspects, the sparse mask comprises a structured sparse mask having a diagonal component and a frequency component. In still other aspects, the sparse mask comprises an unstructured sparse mask based on top-K weight magnitudes, top-K gradients, and/or single shot network pruning. In other aspects, the sparse mask comprises an unstructured mask based on randomly selected trainable parameters.

In some aspects, the processor-implemented method 1100 optionally includes replacing the subset of the number of pre-trained weights with the trained sparse adapter weights (block 1106). For example, a decode operation (op) or look-up table (LUT) may be introduced to take base weights and replace corresponding base model weights with the adapter weights.

### EXAMPLE ASPECTS

Aspect 1: An apparatus, comprising: at least one memory; and at least one processor coupled to the at least one memory, the at least one processor configured to: receive an artificial neural network having a plurality of pre-trained weights; and train a subset of the plurality of pre-trained weights to obtain trained sparse adapter weights for obtaining a fine-tuned version of the artificial neural network, the subset of the plurality of pre-trained weights comprising base model weights of a base model for the artificial neural network, the subset of the plurality of pre-trained weights selected with a sparse mask of a sparse adapter; wherein the trained sparse adapter weights are used to replace the subset of the plurality of pre-trained weights with the trained sparse adapter weights.

Aspect 2: The apparatus of Aspect 1, wherein the sparse mask comprises a plurality of offsetting sparse masks resulting in minimal overlapping for multi-adapter fusion.

Aspect 3: The apparatus of Aspect 1 or 2, wherein the sparse mask comprises a structured sparse mask having a diagonal component and a frequency component.

Aspect 4: The apparatus of Aspect 1, 2, or 3, wherein the sparse mask comprises an unstructured sparse mask based on top-K weight magnitudes.

Aspect 5: The apparatus of Aspect 1, 2, 3, or 4, wherein the sparse mask comprises an unstructured sparse mask based on top-K gradients.

Aspect 6: The apparatus of Aspect 1, 2, 3, 4, or 5, wherein the sparse mask comprises an unstructured sparse mask based on single shot network pruning.

Aspect 7: The apparatus of Aspect 1, 2, 3, 4, 5, or 6, wherein the sparse mask comprises an unstructured sparse mask based on randomly selected trainable parameters.

Aspect 8: The apparatus of any of the preceding Aspects, wherein the at least one processor is further configured to store the trained sparse adapter weights and corresponding indices into a full matrix, the trained sparse adapter weights obtained based on the sparse mask.

Aspect 9: The apparatus of any of the preceding Aspects, wherein the at least one processor is further configured to decode the trained sparse adapter weights and associated indices, with a decode operator, to load the trained sparse adapter weights on to a corresponding subset of pre-trained weights during inference, the trained sparse adapter weights having been obtained from the sparse mask.

Aspect 10: The apparatus of any of the preceding Aspects, wherein the at least one processor is further configured to access a look-up table to enable loading of the trained sparse adapter weights on to the base model weights of the base model during inference, the trained sparse adapter weights having been obtained from the sparse mask.

Aspect 11: The apparatus of any of the preceding aspects wherein the at least one processor is further configured to generate text, generate language, generate an image, and/or generate a video with the artificial neural network, which comprises a generative artificial intelligence (AI) model.

Aspect 12: A processor-implemented method comprising: receiving an artificial neural network having a plurality of pre-trained weights; and training a subset of the plurality of pre-trained weights to obtain trained sparse adapter weights for obtaining a fine-tuned version of the artificial neural network, the subset of the plurality of pre-trained weights comprising base model weights of a base model for the artificial neural network, the subset of the plurality of pre-trained weights selected with a sparse mask of a sparse adapter; wherein the trained sparse adapter weights are used for replacing the subset of the plurality of pre-trained weights with the trained sparse adapter weights.

Aspect 13: The processor-implemented method of Aspect 12, wherein the sparse mask comprises a plurality of offsetting sparse masks resulting in minimal overlapping for multi-adapter fusion.

Aspect 14: The processor-implemented method of Aspect 12 or 13, wherein the sparse mask comprises a structured sparse mask having a diagonal component and a frequency component.

Aspect 15: The processor-implemented method of Aspect 12, 13, or 14, wherein the sparse mask comprises an unstructured sparse mask based on top-K weight magnitudes.

Aspect 16: The processor-implemented method of Aspect 12, 13, 14, or 15, wherein the sparse mask comprises an unstructured sparse mask based on top-K gradients.

Aspect 17: The processor-implemented method of any of the Aspects 12-16, wherein the sparse mask comprises an unstructured sparse mask based on single shot network pruning.

Aspect 18: The processor-implemented method of any of the aspects 12-17, wherein the sparse mask comprises an unstructured sparse mask based on randomly selected trainable parameters.

Aspect 19: The processor-implemented method of any of the Aspects 12-18, further comprising storing the trained sparse adapter weights and corresponding indices into a full matrix, the trained sparse adapter weights obtained based on the sparse mask.

Aspect 20: The processor-implemented method of any of the Aspects 12-19, further comprising decoding the trained sparse adapter weights and associated indices, with a decode operator, to load the trained sparse adapter weights on to a corresponding subset of pre-trained weights during inference, the trained sparse adapter weights having been obtained from the sparse mask.

Aspect 21: The processor-implemented method of any of the Aspects 12-20, further comprising accessing a look-up table to enable loading of the trained sparse adapter weights on to the base model weights of the base model during inference, the trained sparse adapter weights having been obtained from the sparse mask.

Aspect 22: The processor-implemented method of any of the Aspects 12-21, further comprising generating text, generating language, generating an image, and/or generating a video with the artificial neural network, which comprises a generative artificial intelligence (AI) model.

Aspect 23: A non-transitory computer-readable medium having program code recorded thereon, the program code executed by a processor and comprising: program code to receive an artificial neural network having a plurality of pre-trained weights; and program code to train a subset of the plurality of pre-trained weights to obtain trained sparse adapter weights for obtaining a fine-tuned version of the artificial neural network, the subset of the plurality of pre-trained weights comprising base model weights of a base model for the artificial neural network, the subset of the plurality of pre-trained weights selected with a sparse mask of a sparse adapter; wherein the trained sparse adapter weights are used to replace the subset of the plurality of pre-trained weights with the trained sparse adapter weights.

Aspect 24: An apparatus, comprising: means for receiving an artificial neural network having a plurality of pre-trained weights; means for training a subset of the plurality of pre-trained weights to obtain trained sparse adapter weights for obtaining a fine-tuned version of the artificial neural network, the subset of the plurality of pre-trained weights comprising base model weights of a base model for the artificial neural network, the subset of the plurality of pre-trained weights selected with a sparse mask of a sparse adapter; wherein the trained sparse adapter weights are used for replacing the subset of the plurality of pre-trained weights with the trained sparse adapter weights.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus, comprising:
at least one memory; and
at least one processor coupled to the at least one memory, the at least one processor configured to:
receive an artificial neural network having a plurality of pre-trained weights; and
train a subset of the plurality of pre-trained weights to obtain trained sparse adapter weights for obtaining a fine-tuned version of the artificial neural network, the subset of the plurality of pre-trained weights comprising base model weights of a base model for the artificial neural network, the subset of the plurality of pre-trained weights selected with a sparse mask of a sparse adapter;
wherein the trained sparse adapter weights are used to replace the subset of the plurality of pre-trained weights with the trained sparse adapter weights.

2. The apparatus of claim 1, wherein the sparse mask comprises a plurality of offsetting sparse masks resulting in minimal overlapping for multi-adapter fusion.

3. The apparatus of claim 1, wherein the sparse mask comprises a structured sparse mask having a diagonal component and a frequency component.

4. The apparatus of claim 1, wherein the sparse mask comprises an unstructured sparse mask based on top-K weight magnitudes.

5. The apparatus of claim 1, wherein the sparse mask comprises an unstructured sparse mask based on top-K gradients.

6. The apparatus of claim 1, wherein the sparse mask comprises an unstructured sparse mask based on single shot network pruning.

7. The apparatus of claim 1, wherein the sparse mask comprises an unstructured sparse mask based on randomly selected trainable parameters.

8. The apparatus of claim 1, wherein the at least one processor is further configured to store the trained sparse adapter weights and corresponding indices into a full matrix, the trained sparse adapter weights obtained based on the sparse mask.

9. The apparatus of claim 1, wherein the at least one processor is further configured to decode the trained sparse adapter weights and associated indices, with a decode operator, to load the trained sparse adapter weights on to a corresponding subset of pre-trained weights during inference, the trained sparse adapter weights having been obtained from the sparse mask.

10. The apparatus of claim 1, wherein the at least one processor is further configured to access a look-up table to enable loading of the trained sparse adapter weights on to the base model weights of the base model during inference, the trained sparse adapter weights having been obtained from the sparse mask.

11. The apparatus of claim 1, wherein the at least one processor is further configured to generate text, generate language, generate an image, and/or generate a video with the artificial neural network, which comprises a generative artificial intelligence (AI) model.

12. A processor-implemented method comprising:
receiving an artificial neural network having a plurality of pre-trained weights; and
training a subset of the plurality of pre-trained weights to obtain trained sparse adapter weights for obtaining a fine-tuned version of the artificial neural network, the subset of the plurality of pre-trained weights comprising base model weights of a base model for the artificial neural network, the subset of the plurality of pre-trained weights selected with a sparse mask of a sparse adapter;
wherein the trained sparse adapter weights are used for replacing the subset of the plurality of pre-trained weights with the trained sparse adapter weights.

13. The processor-implemented method of claim 12, wherein the sparse mask comprises a plurality of offsetting sparse masks resulting in minimal overlapping for multi-adapter fusion.

14. The processor-implemented method of claim 12, wherein the sparse mask comprises a structured sparse mask having a diagonal component and a frequency component.

15. The processor-implemented method of claim 12, wherein the sparse mask comprises an unstructured sparse mask based on top-K weight magnitudes.

16. The processor-implemented method of claim 12, wherein the sparse mask comprises an unstructured sparse mask based on top-K gradients.

17. The processor-implemented method of claim 12, wherein the sparse mask comprises an unstructured sparse mask based on single shot network pruning.

18. The processor-implemented method of claim 12, wherein the sparse mask comprises an unstructured sparse mask based on randomly selected trainable parameters.

19. The processor-implemented method of claim 12, further comprising storing the trained sparse adapter weights and corresponding indices into a full matrix, the trained sparse adapter weights obtained based on the sparse mask.

20. The processor-implemented method of claim 12, further comprising decoding the trained sparse adapter weights and associated indices, with a decode operator, to load the trained sparse adapter weights on to a corresponding subset of pre-trained weights during inference, the trained sparse adapter weights having been obtained from the sparse mask.

21. The processor-implemented method of claim 12, further comprising accessing a look-up table to enable loading of the trained sparse adapter weights on to the base model weights of the base model during inference, the trained sparse adapter weights having been obtained from the sparse mask.

22. The processor-implemented method of claim 12, further comprising generating text, generating language, generating an image, and/or generating a video with the artificial neural network, which comprises a generative artificial intelligence (AI) model.

23. A non-transitory computer-readable medium having program code recorded thereon, the program code executed by a processor and comprising:
program code to receive an artificial neural network having a plurality of pre-trained weights; and
program code to train a subset of the plurality of pre-trained weights to obtain trained sparse adapter weights for obtaining a fine-tuned version of the artificial neural network, the subset of the plurality of pre-trained weights comprising base model weights of a base model for the artificial neural network, the subset of the plurality of pre-trained weights selected with a sparse mask of a sparse adapter;
wherein the trained sparse adapter weights are used to replace the subset of the plurality of pre-trained weights with the trained sparse adapter weights.

24. An apparatus, comprising:
means for receiving an artificial neural network having a plurality of pre-trained weights; and
means for training a subset of the plurality of pre-trained weights to obtain trained sparse adapter weights for obtaining a fine-tuned version of the artificial neural network, the subset of the plurality of pre-trained weights comprising base model weights of a base model for the artificial neural network, the subset of the plurality of pre-trained weights selected with a sparse mask of a sparse adapter;
wherein the trained sparse adapter weights are used for replacing the subset of the plurality of pre-trained weights with the trained sparse adapter weights.
